(19) United States
(12) Patent Application Publication
(10) Pub. No.: US 2023/0170758 A1
(43) Pub. Date: Jun. 1, 2023

(54) A Submersible Oil-Filled Permanent Magnet Electric Motor

(71) Applicant: Lex Submersible Pumps FZE Company, Moscow (RU)

(72) Inventors: Anton Shakirov, MOSCOW (RU); VITALY KOROPETSKIY, MOSCOW (RU); IAROSLAV ALEKSEEV, MOSCOW (RU); VADIM BATALOV, MOSCOW (RU); ANTON GORISLAVSKIY, TBILISI (GA); ANTON SHKOLNYI, LVIV (UA)

(73) Assignee: Lex Submersible Pumps FZE Company, MOSCOW (RU)

(21) Appl. No.: 17/993,017

(22) Filed: Nov. 23, 2022

Related U.S. Application Data
(60) Provisional application No. 63/283,340, filed on Nov. 26, 2021.

(51) Int. Cl. H02K 5/132; H02K 1/14; H02K 5/20; H02K 9/19

(52) U.S. Cl. CPC H02K 5/132; H02K 1/146; H02K 5/20; H02K 9/19; H02K 2213/03

(57) ABSTRACT

An apparatus is disclosed that increases an efficiency of the submersible brushless motor with annular magnetic segments on the rotor (increase in efficiency) (by minimizing static losses during the passage of the magnetic flux through the stator magnetic circuit) while increasing its meant time between failures (MTBF) by ensuring efficient operation of a cooling circulation circuit electric motor (by simultaneously providing the maximum possible cross-section and the maximum surface for heat transfer in a flow longitudinal circulation channel formed between the surfaces of the magnetic circuit and the rotor).

### CROSS REFERENCE TO RELATED APPLICATION

This patent application claims priority from U.S. patent application Ser. No. 17/717,889 filed on Apr. 11, 2022 entitled A METHOD AND APPARATUS FOR A SUBMERSIBLE MULTISTAGE LABYRINTH-SCREW PUMP, which is hereby incorporated by reference herein in its entirety. This patent application also claims priority from U.S. Provisional patent application Ser. No. 63/298,734 by ANTON Shakirov entitled A METHOD AND APPARATUS FOR A SUBMERSIBLE MULTISTAGE LABYRINTH-SCREW PUMP filed on Jan. 12, 2022, which is hereby incorporated by reference herein in its entirety; this patent application also claims priority from U.S. Provisional patent application Ser. No. 63/283,340 by ANTON Shakirov entitled Submersible Oil-filled Permanent Magnet Electric Motor, filed on 26 Nov. 2021, which is hereby incorporated by reference herein in its entirety; this patent application also claims priority from U.S. Provisional patent application Ser. No. 63/283,342 by ANTON Shakirov entitled Axial Support Shoe Unit of Oil-Filled Submersible Motor filed on 26 Nov. 2021, which is hereby incorporated by reference herein in its entirety; and this patent application claims priority from U.S. Provisional patent application Ser. No. 63/283,343 by ANTON Shakirov entitled Submersible Pump Unit Drive with Heat Exchanger filed on 26 Nov. 2021, which is hereby incorporated by reference herein in its entirety.

### BACKGROUND OF THE INVENTION

The increase in the time between failures of high-speed submersible centrifugal valve pumps driven on the basis of valve electric motors for oil production significantly depends on the resource of such an electric motor, which in turn depends on its thermal regime. The problem of overheating of submersible valve oil-filled electric motors can become especially relevant when intensifying oil production and when using high-power brushless motors. In such engines, circulation circuits of forced cooling are implemented. It is necessary because of the small size of the power unit and intense heat generation in it, and, accordingly, an effective fluid flow is necessary to ensure increased heat transfer from the heating elements of the electric motor. In this regard, it is important to optimize the technical characteristics of the design of submersible oil-filled brushless motors, in particular, the thermal modes of operation of the electric motor (with an increase in their efficiency) due to the optimized geometry of the forced circulation of cooling oil in the oil-filled motor.

RU No. 2277285, publ. 2006 discloses a submersible valve oil-filled electric motor has wherein a submersible valve oil-filled electric motor containing a housing, a stator, a shaft, and on the shaft of each module, there are permanent magnets that are magnetized in the radial direction. The disadvantage of this electric motor is the lack of an efficient engine cooling system. In particular, it does not provide for a developed channel oil-filled cooling system.

RF patent No. 2672858, published in 2018 discloses a submersible oil-filled brushless motor containing elements for oil circulation, a cylindrical housing in which a rotor with a hollow shaft is placed. The cavity of said shaft is configured to circulate oil through it. The stator magnetic circuit contains teeth and quadrangular stator slots of the same cross-section, which are filled with winding wires. The outer surface of the stator magnetic circuit is adjacent to the inner surface of the cylindrical body. Longitudinal recesses (in the form of grooves) are made on the outer surface of the stator magnetic circuit, and longitudinal flow channels for oil circulation are formed, formed by the surfaces of the above longitudinal recesses and the corresponding areas of the inner surface of the cylindrical body located above the longitudinal recesses (see positions 5, 7 in FIG. 1, 2, 3 to RF patent No. 2672858). The number of longitudinal flow channels is made equal to the number of teeth of the stator magnetic circuit. In cross-section, the longitudinal flow channels of cooling (oil as a coolant) are figures that are symmetrical about the radial axis of symmetry of the stator tooth and have a semicircular, triangular, trapezoidal, or semi-ellipse shape. The disadvantage of this technical solution is the lack of optimized forms of these figures, taking into account the peculiarity of the specific distribution of electromagnetic fields along the stator magnetic circuit (directions and values of magnetic induction fluxes) in a valve (synchronous) motor. The non-optimized shape of these figures can lead to a non-optimal distribution of electric fields during the operation of the electric motor (in particular, an increase in the maximum values of magnetic induction), which can lead to a drop in the efficiency of the valve motor and, accordingly, increased overheating of the motor, and as a result, a decrease in reliability (since with an increase in the temperature stator winding, even by a few degrees, the MTBF can be significantly reduced).

### FIELD OF THE INVENTION

The present invention relates to the field of oil engineering, in particular to the design of submersible oil-filled valve (synchronous) electric motors for electric submersible high-speed centrifugal pumps for oil production. These submersible motors can be high speed, 6000 rpm, or higher.

### BRIEF DESCRIPTION OF THE DRAWINGS

FIG. 1 is a schematic depiction of a cross sectional view of a particular illustrative embodiment of the invention depticting a submersible oil-filled valve motor in cross-section;

FIG. 2 is a schematic depiction of a cross sectional view of a particular illustrative embodiment of the invention depticting part of the magnetic circuit with a quadrangular stator groove with rounded upper corners of the stator and an upper longitudinal recess on the surface of the magnetic circuit;

FIG. 3 is a schematic depiction of a cross sectional view of a particular illustrative embodiment of the invention depticting a distribution of electromagnetic induction fields in a submersible oil-filled valve motor in cross-section for the optimal cross-sectional shape of the longitudinal flow channel. (Design model of the intensity of the magnetic induction of the electric motor with the indication of the magnetic flux lines); and

FIG. 4 is a schematic depiction of a perspective view of a particular illustrative embodiment of the invention depticting a stator magnetic circuit with longitudinal flow channels.

### SUMMARY OF THE INVENTION

An apparatus is disclosed that increases an efficiency of the submersible brushless motor with annular magnetic segments on the rotor (increase in efficiency) (by minimizing static losses during the passage of the magnetic flux through the stator magnetic circuit) while increasing its meant time between failures (MTBF) by ensuring efficient operation of a cooling circulation circuit electric motor (by simultaneously providing the maximum possible cross-section and the maximum surface for heat transfer in a flow longitudinal circulation channel formed between the surfaces of the magnetic circuit and the rotor).

### DETAILED DESCRIPTION OF AN ILLUSTRATIVE EMBODIMENT OF THE INVENTION

The specification and drawings are, accordingly, to be regarded in an illustrative rather than a restrictive sense. It will be evident that additions, subtractions, deletions, and other modifications and changes may be made thereunto without departing from the broader spirit and scope of the inventions as set forth in the claims set forth below. Accordingly, the inventions are therefore to be limited only by the scope of the appended claims. None of the claim language should be interpreted pursuant to 35 U.S.C. 112(f) unless the word “means” is recited in any of the claim language, and then only with respect to any recited “means” limitation. The drawings are drawn to scale. In a particular embodiment of the invention an economical submersible valve oil-filled electric motor with an efficient oil-cooled circulation circuit is disclosed.

In a particular illustrative embodiment of the invention, an apparatus is disclosed that increases an efficiency of the submersible brushless motor with annular magnetic segments on the rotor (increase in efficiency) (by minimizing static losses during the passage of the magnetic flux through the stator magnetic circuit) while increasing its meant time between failures (MTBF) by ensuring efficient operation of a cooling circulation circuit electric motor (by simultaneously providing the maximum possible cross-section and the maximum surface for heat transfer in a flow longitudinal circulation channel formed between the surfaces of the magnetic circuit and the rotor). Ultimately, there is a decrease in the thermal loading of the critical components of the brushless electric motor (stator magnetic circuit, shaft). In a particular illustrative embodiment of the invention, an additional advantage of the design is also ensuring the compactness of the brushless motor—the possibility of minimizing the outer diameter of the cylindrical body D and minimizing its length by optimizing the design of the cooling circuit of the submersible brushless motor.

In a particular illustrative embodiment of the invention, a submersible oil-filled reciprocating electric motor is disclosed, containing elements for ensuring oil circulation, a cylindrical body, and a hollow shaft of the rotor. In this case, the shaft cavity is made allowing oil circulation in it. The stator magnetic circuit contains identical teeth and quadrangular stator slots filled with winding wires. The outer surface of the stator magnetic circuit is adjacent to the inner surface of the cylindrical body, while longitudinal recesses are made on the outer surface of the stator magnetic circuit. In the electric motor, longitudinal flow channels for oil circulation are formed, formed by the surfaces of the above longitudinal recesses and the corresponding areas of the inner surface of the cylindrical body located above the longitudinal recesses. The number of longitudinal flow channels is made equal to the number of teeth of the stator magnetic circuit. In cross-section, these longitudinal flow channels form a triangular shape. The triangular shape has two sides with a common vertex that are symmetrical with respect to each other with an axis of symmetry representing the radial axis of symmetry of the stator tooth and a third side formed by the corresponding part of the cylindrical body. An even number of magnetic annular segments are mounted on the hollow shaft of the rotor, each of which is magnetized in the radial direction. The magnetic annular segments form pole pairs with alternating north and south poles in the circular direction of the said rotor shaft. The upper (outer) side of each stator slot is located at a distance h from the inner surface of the cylinder body, while each stator slot in the cross-section has two rounded upper corners. Each upper rounded corner is formed by an arc of a circle with radius R1 and centered at the point Oi′, where i is an integer i from 1 to 2N, where N is the total number of stator slots, while each of the above sides with a common vertex of the above triangular shape is formed arc segment with radius R2=R1+h centered at point Oi′ for each corresponding rounded corner of the stator slot. Note that the intersection of the sides of the above common vertex in this application is defined as a small technological rounding (more precisely, its cross section is a rounded corner with an axis of symmetry passing along the axis of symmetry of the stator tooth) with its own small radius (significantly less than the radius of the main arcs forming symmetrical sides) and this rounding smoothly (on both sides with respect to the symmetry of the tooth) passes and adjoins the main arcs, without significantly changing the triangular shape.

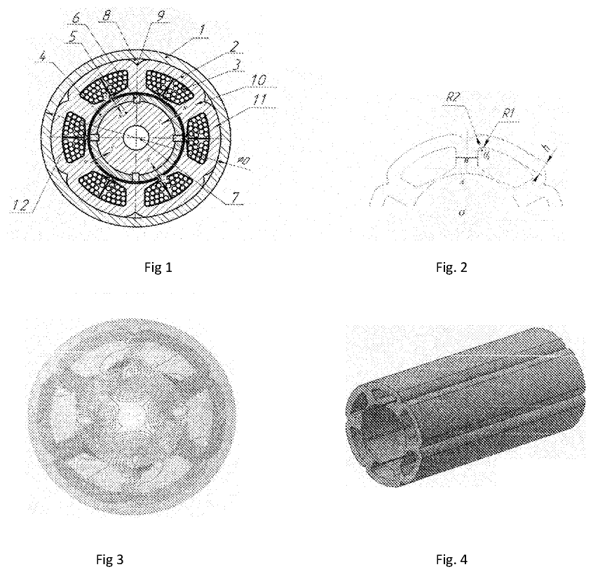

In a particular illustrative embodiment of the invention a submersible oil-filled brushless motor is disclosed having high-speed with a rotation speed of 6000 rpm and higher. The internal cavity of the motor is sealed and filled with dielectric oil to protect the motor from penetration of formation fluid into its cavity, as well as to cool the windings and lubricate the bearings. The electric motor (see FIG. 1) contains elements for ensuring the circulation of oil (for example, pump stages for forced circulation of oil—not shown), a cylindrical body 1 with a diameter D, a hollow shaft of the rotor 5. The shaft cavity (internal axial channel of the shaft 7) is made for oil circulation in it. The stator magnetic circuit 11 (“stator iron”) with a yoke 2 of thickness h contains teeth 10 (each tooth has the same width H) and quadrangular stator slots 12, identical in cross-section, filled with winding wires 3. The outer surface of the stator magnetic circuit 11 is adjacent to the inner surface of the cylindrical housing 1, while longitudinal recesses are made on the outer cylindrical surface of the stator magnetic circuit. In the electric motor, longitudinal flow channels 8 for oil circulation are formed, formed by the surfaces of the longitudinal recesses and the corresponding areas of the inner surface of the cylindrical body 1 located above the longitudinal recesses. The number of longitudinal flow channels 8 is made equal to the number of teeth 10 of the magnetic circuit of the stator 11, which is one of the factors for an effective cooling process (manifesting more uniform temperature equalization around the stator circumference). In cross-section, the aforementioned longitudinal flow channels 8 form a triangular shape. The triangular shape has two sides with a common vertex 9, which are symmetrical with respect to each other, with an axis of symmetry representing the radial axis of symmetry of the stator tooth and a third side formed by the corresponding part of the cylindrical body 1. The intersection of the arc sides symmetrical between themselves is a common vertex 9 (more precisely, it is a rounded corner) is a relatively small technological fillet with its own radius.

On the hollow shaft 5 of the rotor there is an even number of magnetic annular segments 4 (between which are installed dividing tires 6), each of which is magnetized in the radial direction (magnetization directions are shown in FIG. 1). As annular magnetic segments 4, for example, magnets made of rare earth alloys are used, which form pole pairs with alternating north and south poles in the circular direction of the aforementioned rotor shaft 5. The outer side of each stator slot 12 is located at a distance h from the inner surface of the cylinder body, with each stator slot in cross-section having two rounded top corners. (The top corners are the two corners of the quadrangular stator slot that are closest to the cylindrical surface of housing 1). Each upper rounded corner (see FIG. 2) is formed by an arc of a circle with radius R1 and centered at the point Oi′, where i is an integer i from 1 to 2N, where N is the total number of stator slots 12, with each of the above sides with a common vertex of the above triangular figure is formed by an arc segment with radius R2=R1+h centered at the point Oi′ for each corresponding upper rounded corner. The upper side of each stator slot is located at a distance h from the inner surface of the cylinder body. In this application, the thickness of the yoke coincides with the specified distance h, since the outer surface of the stator 11 magnetic circuit is adjacent to the inner surface of the cylindrical housing 1. Note that the above triangular figure, based on the above features of its construction, is a curvilinear triangle with two symmetrical arc concave inside the triangle sides and a side in the form of a convex arc.

In a particular illustrative embodiment of the invention, the present application discloses a three-phase brushless motor. When the electric motor is operating, its control system monitors the position of the rotor, applying a voltage of a certain polarity to the corresponding pair of windings in the stator slots in such a way that the magnetic field excited in the stator carries the rotor with it, causing it to rotate. Radially magnetized ring-type permanent magnets 4 create a magnetic flux passing through the stator magnetic circuit 11, winding wires 3 (usually copper wires), and cylindrical body 1, forming a closed magnetic circuit for the passage of the magnetic flux. The cooling circuit with forced circulation of liquid in a simplified general case works like this—the cooled oil in the heat exchanger (not shown) of the electric motor enters through the axial channel 7 of the rotor and through intermediate channels (not shown) into the flow longitudinal channels 8 on the outer surface of the stator and then through them into the lower area of the engine. In this case, heat transfer occurs from the “stator iron” and the rotor in the oil (dielectric).

The oil is cooled in the heat exchanger and again enters the shaft cavity from below (axial channel 7), and the cooling cycle provided by the circulation elements are repeated. Channels 8 built taking into account the creation of the preferred distribution of magnetic induction fields (their geometric parameters, to a certain extent, determine the necessary structure of the magnetic induction field FIG. 3) and have a shape that provides minimal losses during the passage of the magnetic flux through the stator iron, the substantially maximum possible cross-section and substantially maximum surface for heat transfer. In this case, the substantially minimum possible value of the diameter D is also achieved. Thus, intensive removal of thermal energy from the internal parts of the engine to the heat exchanger by the oil circulating inside is provided, and, consequently, cooling is improved and the thermal loading of its critical components is reduced (for example, the stator magnetic circuit).

FIG. 4 is a schematic depiction of a particular illustrative embodiment of the invention depicting a stator magnetic circuit with longitudinal flow channels.

In a particular illustrative embodiment of the invention, the results of testing the same permanent magnet motors (in the operating mode) differing only in different cross-sections of the longitudinal cooling channel (and taking into account the data of the computational computer modeling of the fields) show the effectiveness of the given shape of the curvilinear triangular cross section of the longitudinal flow channel 8 disclosed herein in this application. An example of calculating magnetic induction fields for such a section shape is shown in FIG. 3. Areas with maximum induction Bmax have an increased density of magnetic induction lines (darker areas). For example, when calculating a specific design, it was equal to Bmax=2.1 Tesla. With grooves of a different shape (and area) different from the preferred one, areas with a higher magnetic flux density Bf (Bf>Bmax) appear (more than there is with the proposed preferred cross-sectional shape, as a result of which losses will increase and the motor efficiency will decrease) or deterioration occurs heat exchange. Note that for submersible asynchronous motors, the pattern of distribution of electromagnetic fields differs from the distribution of fields for submersible valve motors and separate studies are required to find the preferred cross-sectional shapes of longitudinal cooling channels for asynchronous motors.

The triangular curvilinear cross-sectional shape with specified geometric parameters ensures the preferred distribution of electric fields during the operation of the electric motor (in particular, as shown by the results of computer simulation of the fields, the maximum values of magnetic induction B for a given cross-sectional shape are lower than for a semicircular shape, a triangular shape with a different shape sides, as well as many other cross-sectional configurations). This provides an increase in the efficiency of the brushless motor (for example, by 1-2% percent) and, accordingly, reduces the overheating of the brushless motor. The consequence of this is an increase in the reliability of the motor ((since with an increase in the temperature of the stator winding even by a few degrees, the time between failures can significantly decrease (by 1.5-2 times)). In this case, the magnetic flux, passing through the magnetic circuit, turns all the domains (electrical steel of the magnetic circuit) either in the direction of the magnetic field, or in the opposite direction, while the field does work: the crystal lattice of the steel of the magnetic circuit expands, stands out heat and the stator magnetic circuit is heated. Thus, the developed design of a submersible valve oil-filled electric motor has the preferred electromagnetic parameters that provide an efficient cooling circulation circuit and increased time between failures.

In a particular illustrative embodiment of the invention, a submersible oil-filled brushless electric motor contains elements for oil circulation is disclosed, a having a cylindrical body (1), a hollow rotor shaft (5), a stator magnetic circuit (11) containing identical teeth (10), and quadrangular stator slots (12) filled with winding wires (3). The outer surface of the stator magnetic circuit is adjacent to the inner surface of the cylindrical body, and longitudinal recesses are made on it. Longitudinal flow channels (8) for oil circulation are formed by the surfaces of the above longitudinal cavities and the corresponding areas of the inner surface of the cylindrical body. In the cross section, the above longitudinal flow channels form a triangular shape. The figure has two sides with a common vertex (9), which are symmetrical with respect to each other, with an axis of symmetry representing the radial axis of symmetry of the stator tooth. Magnetic annular segments (4) are mounted on the rotor shaft. The upper side of each stator slot is located at a distance h from the inner surface of the cylinder body, with each stator slot in the cross section having two rounded upper corners, each upper rounded corner being formed by an arc of a circle with a radius R1 and centered at point Oi′, where i integer i from 1 to 2N, where N is the total number of stator slots. Each of the above sides with a common vertex of the above triangular shape is formed by an arc segment centered at the point Oi′ for each corresponding upper rounded corner with radius R2=R1+h. The technical result of the utility model is an increase in the efficiency of a submersible brushless motor with a simultaneous increase in its time between failures.

1. An apparatus, the apparatus comprising:
a submersible oil-filled brushless electric motor for ensuring oil circulation, wherein the submersible oil-filled brushless electric motor further comprises,
an electric motor having oil circulation;
a cylindrical housing containing the electric motor;
a rotor in the electric motor;
a hollow shaft in the rotor, for circulating oil in the motor;
a stator magnetic circuit surrounding the rotor;
quadrangular stator grooves on the stator wherein the stator grooves contain teeth and wherein the quadrangular stator grooves are filled with winding wires, wherein an outer surface of the stator magnetic circuit is adjacent to an inner surface of the cylindrical housing, wherein longitudinal recesses are formed on the outer surface of the stator magnetic circuit, wherein longitudinal flow channels for oil circulation are formed in the electric motor, formed by the surfaces of the longitudinal recesses and corresponding areas of the inner surface of the cylindrical housing located above the longitudinal recesses, wherein a number of the longitudinal flow channels is equal to the number of teeth of the stator magnetic circuit, wherein a cross section the longitudinal flow channels form a substantially triangular shape, wherein the triangular shape has two sides with a common vertex that are symmetrical with respect to each other with an axis of symmetry representing a radial symmetry axis of a stator tooth and a third side formed by a corresponding part of an adjacent cylindrical body, and an even number of magnetic annular segments are installed on the hollow shaft of the rotor, each of which is magnetized in a radial direction, wherein the magnetic annular segments form pairs of poles with alternating north and south poles in a circular direction of the rotor shaft, and the outer side of each stator slot is located at a distance h from the inner surface of a cylinder housing adjacent to the outer surface of the stator magnetic circuit, while each stator groove in cross section has two rounded upper corners, each upper rounded corner being formed by an arc of a circle with a radius R1 and centered at a point Oi′, where i is an integer i from 1 to 2N, where N is a total number of stator slots, while each of the sides with a common vertex of a triangular figure is formed by an arc segment with a radius R2=R1+h centered at point Oi′ for each respective top rounded corner of the stator slot.

2. An apparatus, the apparatus comprising:
a submersible oil-filled brushless electric motor for ensuring oil circulation, wherein the submersible oil-filled brushless electric motor further comprises,
an electric motor having oil circulation;
a cylindrical housing containing the electric motor;
a rotor in the electric motor;
a hollow shaft in the rotor, for circulating oil in the motor;
a stator magnetic circuit surrounding the rotor; and
quadrangular stator grooves on the stator wherein the stator grooves contain teeth and quadrangular stator grooves filled with winding wires, while an outer surface of the stator magnetic circuit is adjacent to an inner surface of the cylindrical housing.

3. The apparatus of claim 2, wherein longitudinal recesses are made on the outer surface of the stator magnetic circuit.

4. The apparatus of claim 3, wherein longitudinal flow channels for oil circulation are formed in the electric motor, formed by the surfaces of the longitudinal recesses and corresponding areas of the inner surface of the cylindrical housing located above the longitudinal recesses.

5. The apparatus of claim 4, wherein a number of the longitudinal flow channels is equal to a number of teeth of the stator magnetic circuit.

6. The apparatus of claim 5, wherein a cross section the longitudinal flow channels form a substantially triangular shape, wherein the triangular shape has two sides with a common vertex that are symmetrical with respect to each other with an axis of symmetry representing a radial symmetry axis of a stator tooth and a third side formed by a corresponding part of an adjacent cylindrical body, and an even number of magnetic annular segments are installed on the hollow shaft of the rotor, each of which is magnetized in a radial direction.

7. The apparatus of claim 6, wherein the magnetic annular segments form pairs of poles with alternating north and south poles in a circular direction of the rotor shaft, and an outer side of each stator slot is located at a distance h from an inner surface of the cylindrical housing adjacent to an outer surface of the stator magnetic circuit, while each stator groove in cross section has two rounded upper corners, each upper rounded corner being formed by an arc of a circle with a radius R1 and centered at a point Oi′, where i is an integer i from 1 to 2N, where N is a total number of stator slots, while each of the sides with a common vertex of a triangular figure is formed by an arc segment with a radius R2=R1+h centered at point Oi′ for each respective top rounded corner of the stator slot.
